(19) United States
(12) Patent Application Publication
(10) Pub. No.: US 2009/0153323 A1
(43) Pub. Date: Jun. 18, 2009

(54) ALARM ACTIVATION AND DEACTIVATION

(75) Inventors: Peter Dam Nielsen, Kgs Lyngby (DK); Christian Rossing Kraft, Frederiksberg (DK)

Correspondence Address: PERMAN & GREEN, 425 POST ROAD, FAIRFIELD, CT, 06824, US

(73) Assignee: NOKIA CORPORATION

(21) Appl. No.: 11/958,017

(22) Filed: Dec. 17, 2007

(51) Int. Cl. G08B 21/00; G08B 21/18

(52) U.S. Cl. 340/540

(57) ABSTRACT

A method including detecting a coupling of a device with an external unit and automatically enabling an alert in the device to activate at a preset time when the coupling is detected.

### BACKGROUND

1. Field

The disclosed embodiments generally relate to user interfaces and, more particularly, to automatically activating an alarm function in a device.

2. Brief Description of Related Developments

Generally users of mobile communication devices charge the batteries in the devices when the user is sleeping. Charging the mobile communication device when the user is sleeping is convenient, as this is a period of time during which the device is typically not being used. Charging the communication device while the user is sleeping also allows the user to bring a fully charged communication device with them when they get out of bed. When the user is in bed, he or she is most likely to leave the communication device in an easily accessible location so that the communication device can be accessed in the event the user receives a communication. Leaving the communication device in an accessible location also allows the user to use these devices as alarm clocks to awake them from sleep. As such, many mobile communication device users keep charging devices in their bedrooms so that the communication device can charge in a convenient location that is easily accessible when the user is in bed.

A user's evening routines may include charging the communication device and setting an alarm. Generally alarms are set in a mobile communication device by navigating through one or more menus. Navigating through the menus to set the alarm clock can be tedious and time consuming for the user.

It would be advantageous to utilize the knowledge of a user's behavior to provide a quick and easy way to carry out the user's daily routines.

### SUMMARY

In one aspect, the disclosed embodiments are directed to a method. In one embodiment the method includes detecting a coupling of a device with an external unit and automatically enabling an alert in the device to activate at a preset time when the coupling is detected.

In another aspect, the disclosed embodiments are directed to an apparatus. In one embodiment the apparatus includes a processor and a display connected to the processor, wherein the processor is configured to detect a coupling of the apparatus with an external unit and automatically enable an alert in the apparatus to activate at a preset time when the coupling is detected.

In another aspect, the disclosed embodiments are directed to a user interface. The user interface includes an input device configured for selecting one or more alert times in an apparatus, a display and a processor connected to the input device and display, the processor being configured to detect a coupling of the apparatus with an external unit and automatically enable an alert in the apparatus to activate at a preset time when the coupling is detected.

In one aspect, the disclosed embodiments are directed to an external device. The external device includes a processor and a memory, wherein the processor is configured to detect a coupling of the external device to an apparatus and automatically enable an alert in the apparatus to activate at a preset time when the coupling is detected.

In another aspect, the disclosed embodiments are directed to a system. The system includes an external device and a mobile communication device configured for coupling with the external device, wherein an alert is automatically enabled in the mobile communication device to activate at a preset time when a coupling is detected between the external device and the mobile communication device.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A and 2B illustrate settings menus in accordance with the disclosed embodiments;

FIG. 3 illustrates a flow diagram in accordance with an aspect of the disclosed embodiments;

FIGS. 4A-4E are illustrations of exemplary screen shots of a user interface in accordance with the disclosed embodiments;

FIGS. 5A and 5B are illustrations of examples of devices that can be used to practice aspects of the disclosed embodiments;

FIG. 6 illustrates a block diagram of an exemplary system incorporating features that may be used to practice aspects of the disclosed embodiments; and

FIG. 7 is a block diagram illustrating the general architecture of an exemplary system in which the exemplary devices of FIGS. 5A and 5B may be used.

### DETAILED DESCRIPTION OF THE EMBODIMENT(s)

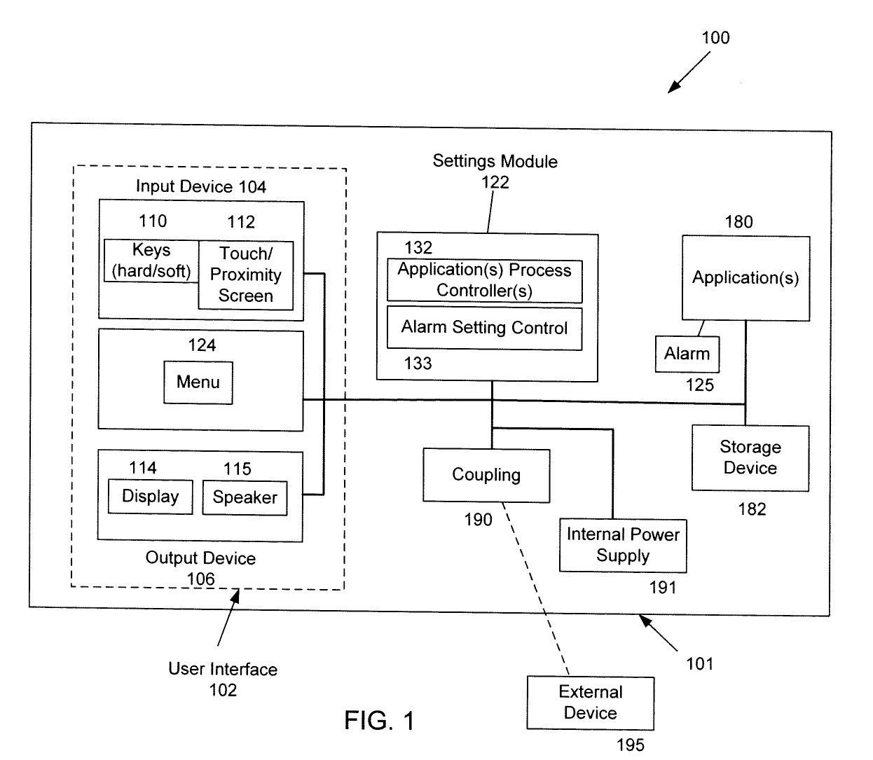

FIG. 1 illustrates one embodiment of a system 100 in which aspects of the disclosed embodiments can be used. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments generally allow for the setting or activation of an alert or alarm when a device 101 is coupled to any suitable external device 195 including, but not limited to, a power supply, charger, a docking cradle, base station, holder, etc. When the device 101 is coupled to the external device 195 through, for example, coupling 190, the device automatically sets or activates the alarm or prompts the user to set the alarm. Automatically setting or activating the alarm or prompting the user to do set the alarm as described herein allows for setting/activating the alarm without the user having to navigate through one or more menus to set/activate the alarm.

In one aspect the device 101 includes a menu 124 that allows a user to select an application or setting that will allow the user to configure one or more alarms and settings. The menu 124 can include any suitable menu items for allowing the user to specify times and dates for each of the alarms 125. The device 101 can be configured to set alarms based on, for example, the last used alarm or setting, a list of alarms or settings, a day of the week, or any other suitable criteria as will be described in greater detail below.

The disclosed embodiments also allow for the deactivation of the alarm when the device 101 is decoupled or disconnected from the external device 195.

In one embodiment, still referring to FIG. 1, the device 101 can include an input device 104, output device 106, settings module 122, applications area 180, and storage 182. The settings module 122 can include a application controller 132 and an alarm setting control 133 and the applications area 180 can include an alarm application 125. The application controller 132 and alarm setting control 133 allow the user to configure the alarms and/or settings with respect to setting the alarm when the device 101 is coupled to the external device 195. The application controller 132 may also be configured to implement the activation of the alarm 125. It is noted that while the application controller 132 and the alarm setting control 133 are shown as separate modules they may be integrated into a single module. It is further noted that the components described herein are merely exemplary and are not intended to encompass all components that can be included in the device 101. For example, in one embodiment, the device 101 comprises a mobile communication device or Internet and application enabled device. In one embodiment the applications of the device 101 may include, but are not limited to, data acquisition (e.g. image, video and sound), and multimedia players (e.g. video and music players). Thus, in alternate embodiments, the device 101 can include other suitable modules and applications for monitoring application content and acquiring data and providing communication capabilities in such a device. While the input device 104 and output device 106 are shown as separate devices, in one embodiment, the input device 104 and output device 106 can be combined and be part of, and form, the user interface 102.

In one embodiment, the user interface 102 of the disclosed embodiments can be implemented on or in a device that includes a touch screen display or a proximity screen device 112. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not necessarily require direct contact, but can include near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where navigation on the display is performed through, for example, keys 110 of the device 101 or through voice commands via voice recognition features of the device 101.

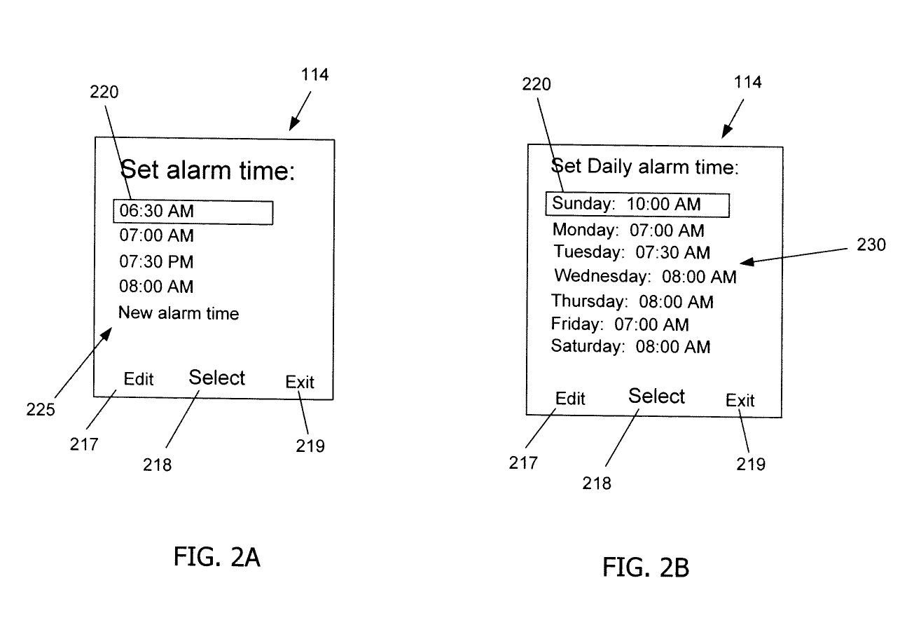

In one embodiment the alarms 125 can be set in any suitable manner before or after the device 101 is connected to the external device 195. In one example, as can be seen in FIG. 2A, the alarms can include separate alarm times 225 that are set by the user. The separate alarm times 225 can be selected in any suitable manner such as through any suitable hard or soft keys 110, touch screen 112 and/or voice commands of the device 101. The soft keys functions may be any suitable functions that allow the user to set or activate the alarm 125. In this example, the soft keys 110 include an edit function 217, a select function 218 and an exit function 219 that allow the user to define and edit the alarm times 225 through, for example one or more of the application process controller 132 and the alarm setting control 133. The selected alarm time can be highlighted or otherwise indicated to the user in any suitable manner. In this example a box 220 is presented around the selected alarm time. These separate alarm times can be repeated on a regular basis (i.e. schedule) so that the user is alerted at the same time each day. In another example, the alarms can be dependent on any suitable criteria or event. For example, as can be seen in FIG. 2B, the alarms can be dependent on a day of the week or calendar events. In the example shown in FIG. 2B, the daily alarms 230 include alarms for each day of the week. The daily alarms can be edited, selected and indicated to the user in substantially the same manner as that indicated above with respect to FIG. 2A. Although one alarm is shown for each day, in other embodiments any suitable number of alarms can be set for each day. In another example, a calendar application of the device 101 can be used to set alarms for any given day.

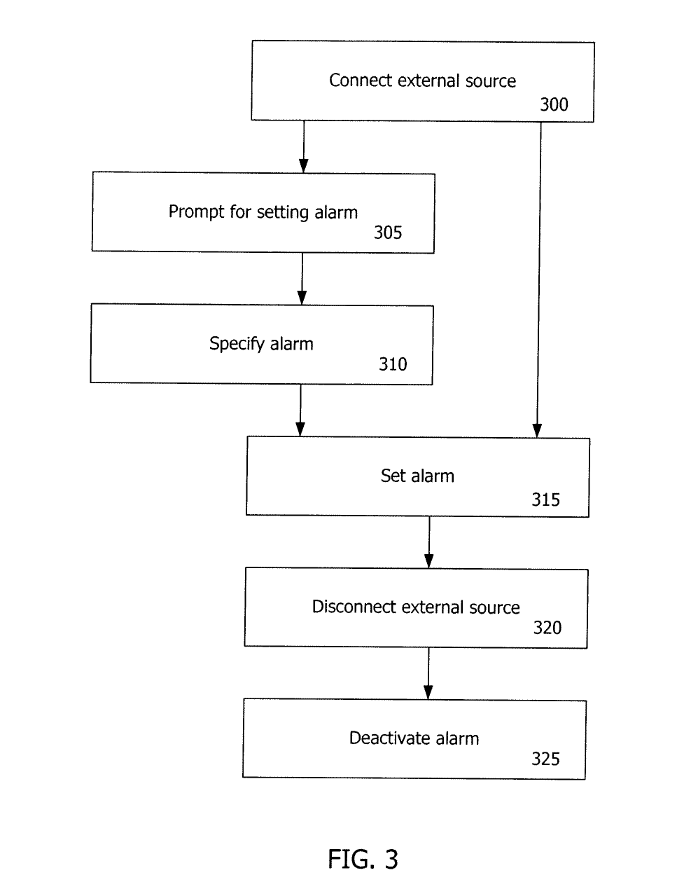

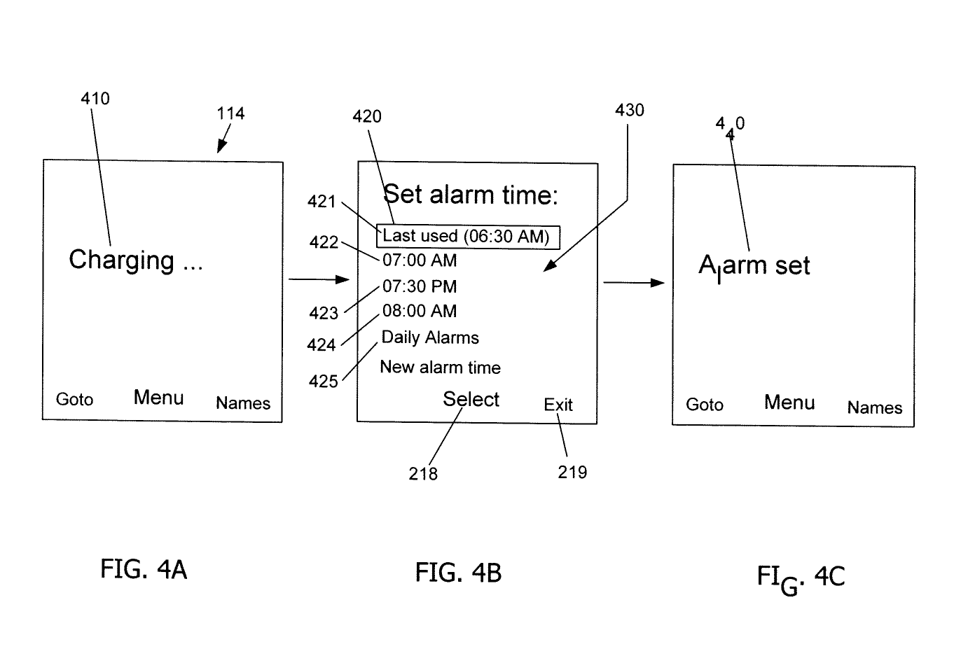

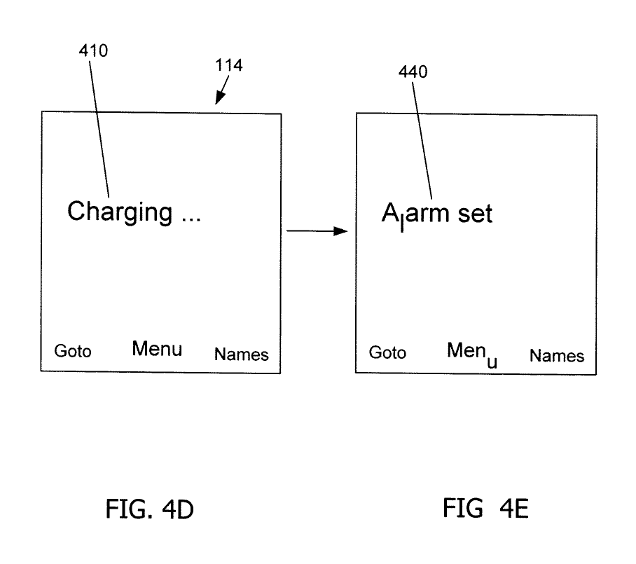

Referring to FIGS. 3 and 4A-4C, an exemplary process for setting one or more alarms will be described. In one embodiment, the device 101 can be configured to prompt the user for an alarm selection when the device 101 is coupled to the external device 195. It is noted that in one embodiment, the device 101 may be configured to recognize the coupling of the external device 195 (without a transfer of power to the device 101) and/or the transfer of power (such as when charging) so that the user is prompted to set the alarm even if power is not being transferred or transmitted to the device 101. In one example, coupling the device 101 to the external device 195 can include a physical or non-physical couplings (e.g. wired, optical, infrared, etc.). In still other embodiments, the device 101 may be configured to sense a proximity of any suitable device (e.g. docking cradle, charger, etc.) such that when the device 101 is placed within a predetermined distance to, for example the cradle the user is prompted to set the alarm(s) 125.

In another example, the external device 195 may be configured to recognize coupling of the device 101 so that the external device 195 automatically triggers the setting of the alarm. As a non-limiting example, the external device 195 may be any suitable computer that is coupled to the device 101. When the external device 195 detects a coupling of the device 101, any suitable processor of the external device 195 may instruct the device 101 in any suitable manner to enable an alarm activation such as, for example, the prompt described above. In other embodiments, the external device 195 can be configured to directly set the alarm in the device 101. For example, the external device may send instructions for enabling an alarm in the device 101 based on any suitable functions/applications stored in a memory of and/or accessible (via any suitable network) to the external device 195 including, but not limited to, calendar, reminder and notebook applications. In one embodiment where the external device 195 directly sets the alarm a prompt may be presented to the user to verify or accept the alarm setting. In other embodiments, the external device 195 may be configured to instruct the device 101 to enable an alarm without providing a prompt to the user. In still other embodiments, the external device 195 may be configured to enable the alarm in the device in any suitable manner including, but not limited to those described herein with respect to the device 101.

In this example, the device 101 is coupled to any suitable external device 195 (FIG. 3, Block 300) through coupling 190. Upon coupling to the external device 195, the device 101 indicates to the user that the coupling is made in any suitable manner. For example, a light on the output device 106 may light up or blink or a message 410 may appear on the display 114 of the device 101 as can be seen in FIG. 4A. In this example, the message 410 on the display 114 indicates that the device 101 is charging, but in other embodiments any suitable message may be presented.

In one embodiment, upon connecting the external device 195 to the device 101, the user is prompted in any suitable manner to set the alarm 125 (FIG. 3, Block 305). In this example, the device 101 presents the user with one or more alarm selections or options 430, as can be seen in FIG. 4B. For exemplary purposes only, the user is presented with options for selecting the last used alarm time 421, other alarm times 422-424 that were previously used by the user, the daily alarms 425 (which may be similar to alarms 230 in FIG. 2B) and creating a new alarm time 426. It is noted that in other embodiments the user may be presented with any suitable alarm options including, but not limited to, alarms from a calendar application or other applications 180 of the device 101. The user selects the alarm options 430 (FIG. 3, Block 310) in any suitable manner. As noted above with respect to FIG. 2A, a box 420 is presented around the currently selected alarm option but in other examples, any suitable indicator that an alarm option is selected may be presented to the user. When the user selects the alarm, the device 101 indicates that the alarm has been set in any suitable manner (FIG. 3, Block 315). For example, the device 101 may present a message 440 on the display 114 or cause any other suitable audible, visible or tactile indicator (e.g. beeps, lights, vibrations, etc.) indicating the alarm 125 is set.

In another embodiment, the device 101 may be configured to automatically set the alarm when the device 101 is coupled to, for example, the external device 195. Referring to FIGS. 4D and 4E, in this embodiment when the device 101 is coupled to the external device 195 (FIG. 3, Block 300), the message 410 is presented indicating that the external device 195 is coupled. The device 101 automatically sets the alarm (FIG. 3, Block 315) and presents the indication 440 that the alarm has been set. In this embodiment, the user has previously selected which alarm is used in any suitable manner such as, for example, in the manner described above with respect to FIGS. 2A and 2B. In other embodiments, the device 101 may automatically select a default alarm time previously defined by the user if no alarm is selected. In other embodiments, the device 101 may review calendar events for any given day and automatically select an alarm in accordance with the events of that day. For example, the device 101 may read an entry from the calendar application indicating the user has a job interview at 9:00 A.M. on Wednesday. The device 101 can automatically set the alarm for 8:00 A.M. on Wednesday or any other suitable time that would give the user adequate time to prepare and travel to the interview. In another embodiment, when automatically selecting the alarm time from a calendar entry, the device 101 can calculate the user's travel time to an event indicated by the calendar entry through, for example, a global positioning system or other navigational features of the device 101. A time of day may also be considered to account for traffic delays if the navigational features of the device 101 do not include such traffic information.

In one embodiment, setting the alarm 125 when the device 101 is connected to the external device 195 as described herein may be dependent on a time of day. The device 101 can include a setting that allows the user to specify a time period for setting the alarm 125 when the external device 195 is connected. For example, the user may specify that the alarm 125 is to be set when the external device 195 is coupled to the device 101 between the predetermined hours of 9:00 P.M. and 2:00 A.M. In this example, if the external device 195 is coupled to the device 101 at any other time the alarm 125 will not be set. For example, if the external device 195 is connected to the device 101 at 3:00 P.M. the alarm will not be set. The predetermined time for setting the alarm 125 when the device 101 is connected to the external device 195 can be user settable.

In one embodiment the alarms 125 in device 101 are presented to a user in any suitable manner such as, for example, through the output device 106 of the user interface 102. For example, the alarms 125 can be presented by visual, audible and tactile (e.g. vibration) stimuli or alerts or any combination thereof. In one example, the alarms 125 can be presented through speaker 115. In other examples the alarms 125 can be presented through the display 114 or through a combination of the display 114 and speaker 115. The alarms 125 can be any suitable alarms including, but not limited, buzzers, beeps, ring tones, sound clips, music files, illuminated lights and video images.

The device 101 can also be configured to turn off, suspend or otherwise stop an alarm when the device 101 is disconnected or decoupled from the external device 195 (FIG. 3, Blocks 320 and 325). For example, when an alarm is activated to wake the user, the user can turn off the alarm by disconnecting an external power source or by removing device 101 from a cradle or other docking device or station. In another embodiment, the device 101 may also be configured to cancel an alarm if the external device 195 is disconnected before the alarm is activated (although there may be settings to activate the alarm even if the external device is disconnected in the event the disconnection is accidental). In yet another embodiment, the device 101 can be configured to set a “snooze” function of the alarm when the external device 195 is disconnected. For example, when an alarm is activated to wake the user and the user disconnects the external device 195, the device 101 may reset or suspend the alarm so the alarm is activated at a later time. For example the later time may be any suitable predetermined amount of time such as, for example, ten minutes or any other suitable time period giving the user additional time to sleep before the alarm is reactivated. The user may also stop or cancel an alarm without disconnecting the external device 195 in any suitable manner such as the input device 104 and/or voice activation.

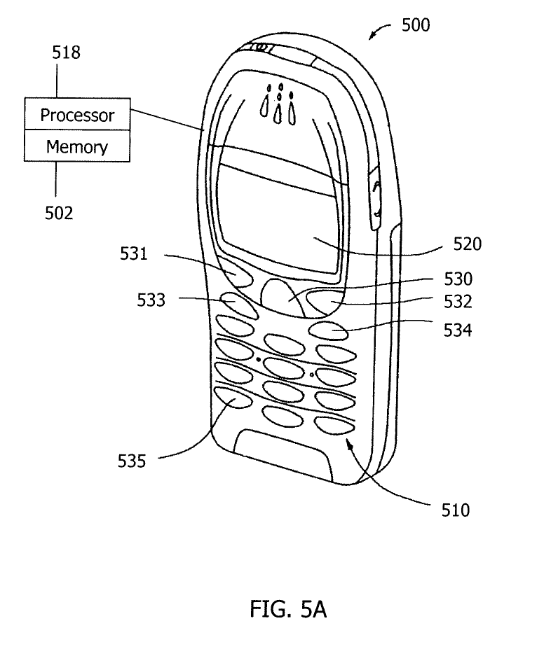

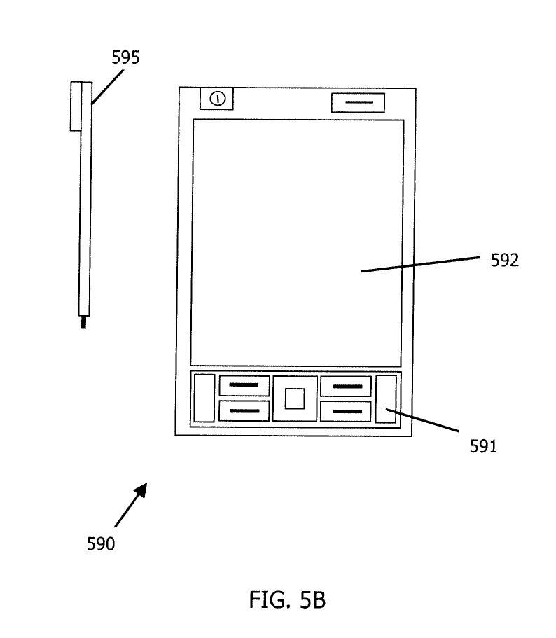

Examples of devices on which aspects of the disclosed embodiments can be practiced are illustrated with respect to FIGS. 5A and 5B. The terminal or mobile communications device 500 may have a keypad 510 and a display 520. The keypad 510 may include any suitable user input devices such as, for example, a multi-function/scroll key 530, soft keys 531, 532, a call key 533, an end call key 534 and alphanumeric keys 535. The display 520 may be any suitable display, such as for example, a touch screen display or graphical user interface. The display 520 may be integral to the device 500 or the display 520 may be a peripheral display connected to the device 500. As noted earlier, the display 520 can be a touch screen display, proximity screen device or graphical user interface. A pointing device, such as for example, a stylus, pen or simply the user's finger may be used with the display 520. In alternate embodiments any suitable pointing device may be used. In other alternate embodiments, the display 520 may be any suitable display, such as for example a flat display that is typically made of an liquid crystal display (LCD) with optional back lighting, such as a thin film transistor (TFT) matrix capable of displaying color images. In alternate embodiments any suitable pointing device may be used. In other alternate embodiments, the display may be a conventional display. The device 500 may also include other suitable features such as, for example, a camera, loud speaker, microphone, connectivity port or tactile feedback features. The mobile communications device may have a processor 518 connected to the display for processing user inputs and displaying information on the display 520. A memory 502 may be connected to the processor 518 for storing any suitable information and/or applications associated with the mobile communications device 500 such as phone book entries, calendar entries, etc.

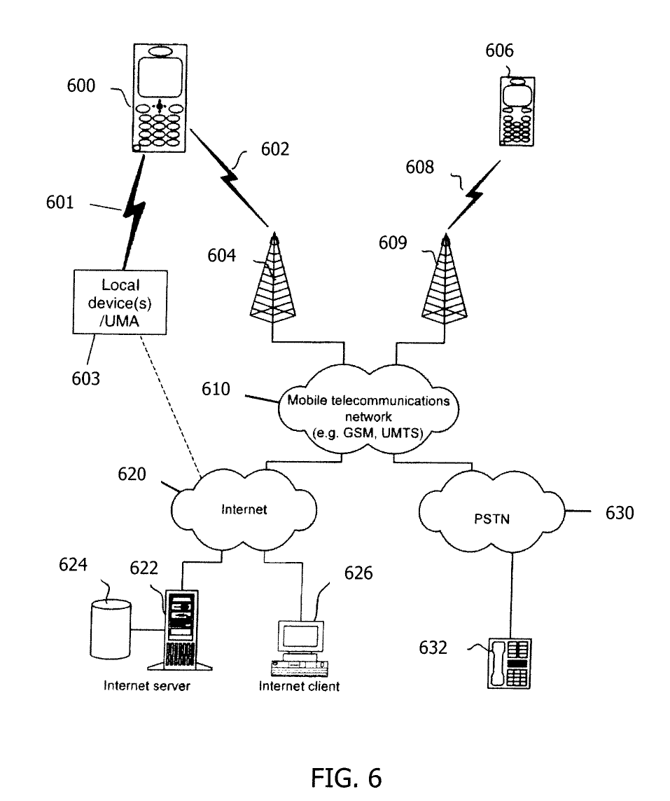

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 600 and other devices, such as another mobile terminal 606, a line telephone 632, a personal computer 626 and/or an internet server 622. It is to be noted that for different embodiments of the mobile terminal 600 and in different situations, some of the telecommunications services indicated above may or may not be available. The aspects of the disclosed embodiments are not limited to any particular set of services in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. An Internet server 622 has data storage 624 and is connected to the wide area network 620, as is an Internet client computer 626. The server 622 may host a worldwide web/wireless application protocol server capable of serving worldwide web/wireless application protocol content to the mobile terminal 600.

A public switched telephone network (PSTN) 630 may be connected to the mobile telecommunications network 610 in a familiar manner. Various telephone terminals, including the stationary telephone 632, may be connected to the public switched telephone network 630.

The mobile terminal 600 is also capable of communicating locally via a local link 601 to one or more local devices 603. The local link 601 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 603 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the device 101 of FIG. 1 can include a communications module that is configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the device 101 of FIG. 1 may be for example, a personal digital assistant (PDA) style device 590 illustrated in FIG. 5B. The personal digital assistant 590 may have a keypad 591, a touch screen display 592 and a pointing device 595 for use on the touch screen display 592. In still other alternate embodiments, the device may be a personal computer, a tablet computer, touch pad device, Internet tablet, a mobile terminal, a cellular/mobile phone, a multimedia device, a personal communicator, or any other suitable device capable of containing for example a display 114 shown in FIG. 1, and supported electronics such as the processor 518 and memory 502 of FIG. 5A.

The user interface 102 of FIG. 1 can also include menu systems 124 associated with the settings module 122. The settings module 122 provides for the control of certain processes of the device 101 including, but not limited setting the alarms as described herein. The menu system 124 can provide for the selection of different tools, settings and application options related to the applications or programs running on the device 101. In one embodiment, the menu system 124 may provide for the selection of applications or features associated with the alarm 125 such as, for example, any suitable setting features including, but not limited to, the settable features described herein. In the embodiments disclosed herein, the settings module 122 receives certain inputs, such as for example, signals, transmissions, instructions or commands related to the functions of the device 100, such as information pertaining to the alarm 125. Depending on the inputs, the settings module 122 interprets the commands and directs, for example, the process control 132 and/or alarm setting control 133 to execute the commands accordingly.

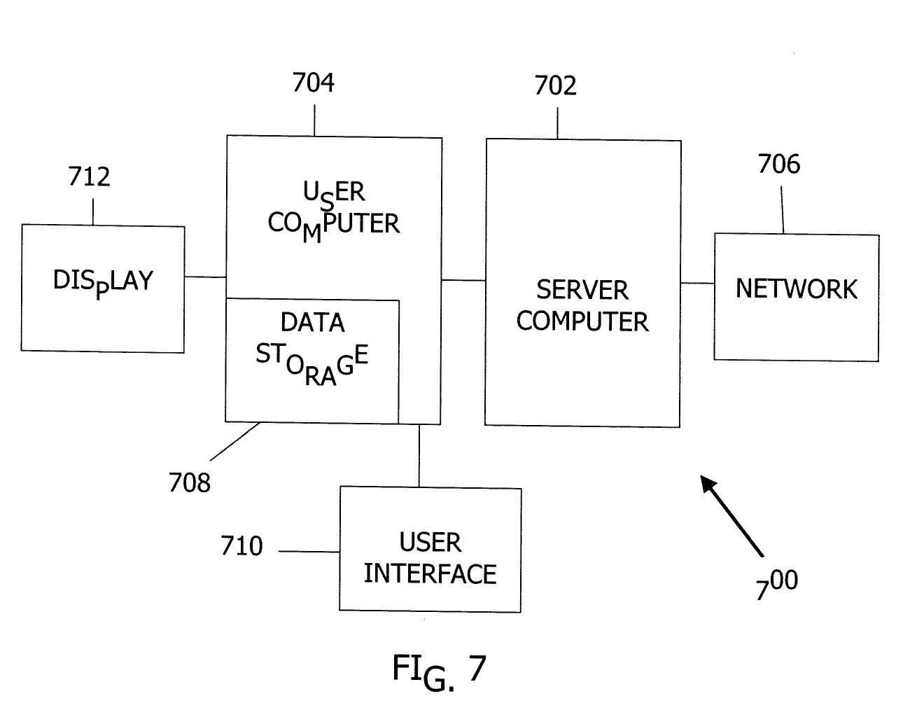

The disclosed embodiments may also include software and computer programs incorporating the process steps and instructions described above that are executed in different computers. FIG. 7 is a block diagram of one embodiment of a typical apparatus 700 incorporating features that may be used to practice aspects of the invention. The apparatus 700 can include computer readable program code means for carrying out and executing the process steps described herein. As shown, a computer system 702 may be linked to another computer system 704, such that the computers 702 and 704 are capable of sending information to each other and receiving information from each other. In one embodiment, computer system 702 could include a server computer adapted to communicate with a network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on an integrated services digital network (ISDN) line. Computers 702 and 704 are generally adapted to utilize program storage devices embodying machine-readable program source code, which is adapted to cause the computers 702 and 704 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 704 may include a data storage device 708 on its program storage device for the storage of information and data. The computer program or software incorporating the processes and method steps incorporating aspects of the invention may be stored in one or more computers 702 and 704 on an otherwise conventional program storage device. In one embodiment, computers 702 and 704 may include a user interface 710, and a display interface 712 from which aspects of the invention can be accessed. The user interface 710 and the display interface 712 can be adapted to allow the input of queries and commands to the system, as well as present the results of the commands and queries.

The embodiments described herein provide a fast and seamless way to set an alarm 125 when the device 101 is coupled to an external device 195. The user of the device 101 does not have to navigate any menus to set an alarm after the device 101 is coupled to the external device 195. The disclosed embodiments also take into account that users of mobile communication devices charge the devices when the user is sleeping. It is noted that while the disclosed embodiments have been described with setting an alarm with respect to waking a user from sleep, the disclosed embodiments are equally applicable to alerting a user when the user is awake.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a coupling of a device with an external unit; and
automatically enabling an alert in the device to activate at a preset time when the coupling is detected.

2. The method of claim 1, further comprising after detecting the coupling of the device with the external unit:
automatically prompting the user to select an alert time; and
enabling the alert to activate at the selected alert time.

3. The method of claim 2, wherein the prompt is an alert selection menu that allows the user to select at least a last used alarm, a list of previous alarms, alarms based on a day of the week and alarms based on calendar entries.

4. The method of claim 1, wherein the alert is enabled with or without a transfer of power to the device from the external unit.

5. The method of claim 1, further comprising after detecting the coupling of the device with the external unit:
determining a time that the coupling is detected; and
automatically setting the alert if the time is within a predetermined time period.

6. The method of claim 1, further comprising after detecting the coupling of the device with the external unit:
detecting when the external unit is decoupled from the device; and
automatically preventing the alert from being activated, deactivating the alert or suspending the alert.

7. A computer program product embodied in a memory of a device comprising:
computer readable program code embodied in a computer readable medium for executing the method of claim 1.

8. The computer program product of claim 7, further comprising computer readable program code embodied in a computer readable medium for, after detecting the coupling of the device with the external unit:
automatically prompting the user to select an alert time; and
enabling the alert to activate at the selected alert time.

9. The computer program product of claim 8, wherein the prompt is an alert selection menu that allows the user to select at least a last used alarm, a list of previous alarms, alarms based on a day of the week and alarms based on calendar entries.

10. The computer program product of claim 7, further comprising computer readable program code embodied in a computer readable medium for, after detecting the coupling of the device with the external unit:
determining a time the external unit is coupled to the device; and
automatically setting the alert if the time is within a predetermined time period.

11. The computer program product of claim 7, further comprising computer readable program code embodied in a computer readable medium for, after detecting the coupling of the device with the external unit:
detecting when the external unit is decoupled from the device; and
automatically preventing the alert from being activated, deactivating the alert or suspending the alert.

12. An apparatus comprising:
a processor; and
a display connected to the processor;
wherein the processor is configured to:
detect a coupling of the apparatus with an external unit; and
automatically enable an alert in the apparatus to activate at a preset time when the coupling is detected.

13. The apparatus of claim 12, wherein after detecting the coupling of the apparatus with the external unit the processor is further configured to:
automatically prompt the user to select an alert time; and
enable the alert to activate at the selected alert time.

14. The apparatus of claim 13, wherein the prompt is an alert selection menu that allows the user to select at least a last used alarm, a list of previous alarms, alarms based on a day of the week and alarms based on calendar entries.

15. The apparatus of claim 12, wherein the alert is enabled with or without a transfer of power to the apparatus from the external unit.

16. The apparatus of claim 12, wherein after detecting the coupling of the apparatus with the external unit the processor is further configured to:
determine a time that the coupling is detected; and
automatically set the alert if the time is within a predetermined time period.

17. The apparatus of claim 12, wherein after detecting the coupling of the apparatus with the external unit the processor is further configured to:
detect when the external unit is disconnected from the apparatus; and
automatically prevent the alert from being activated, deactivate the alert or suspend the alert.

18. The apparatus of claim 12, wherein the apparatus comprises a mobile communication device.

19. A user interface comprising:
an input device configured for selecting one or more alert times in an apparatus;
a display; and
a processor connected to the input device and display, the processor being configured to:
detect a coupling of the apparatus with an external unit; and
automatically enable an alert in the apparatus to activate at a preset time when the coupling is detected.

20. The user interface of claim 19, wherein after detecting the coupling of the apparatus with the external unit the processor is further configured to:
automatically prompt the user to select an alert time; and
enable the alert to activate at the selected alert time.

21. The user interface of claim 20, wherein the prompt is an alert selection menu that allows the user to select at least a last used alarm, a list of previous alarms, alarms based on a day of the week and alarms based on calendar entries.

22. The user interface of claim 19, wherein after detecting the coupling of the apparatus with the external unit the processor is further configured to:
determine a time that the coupling is detected; and
automatically set one or more of the alert times if the time is within a predetermined time period.

23. The user interface of claim 19, wherein after detecting the coupling of the apparatus with the external unit the processor is further configured to:
detect when the external unit is decoupled from the apparatus; and
automatically prevent the alert from being activated, deactivate the alert or suspend the alert.

24. An external device comprising:
a processor; and
a memory;
wherein the processor is configured to:
detect a coupling of the external device to an apparatus; and
automatically enable an alert in the apparatus to activate at a preset time when the coupling is detected.

25. The external device of claim 24, wherein the external device enables the alert without prompting a user.

26. The external device of claim 24, wherein the apparatus is a mobile communication device.

27. A system comprising:
an external device; and
a mobile communication device configured for coupling with the external device, wherein an alert is automatically enabled in the mobile communication device to activate at a preset time when a coupling is detected between the external device and the mobile communication device.

28. The system of claim 27, wherein the external device detects the coupling and enables the alert.

29. The system of claim 27, wherein the mobile communication device detects the coupling and automatically enables the alert.

30. The system of claim 27, wherein after detecting the coupling of the mobile communication device with the external device the system is further configured to:
automatically prompt the user to select an alert time; and
enable the alert to activate at the selected alert time.

31. The system of claim 30, wherein the prompt is an alert selection menu that allows the user to select at least a last used alarm, a list of previous alarms, alarms based on a day of the week and alarms based on calendar entries.

32. The system of claim 27, wherein after detecting the coupling of the mobile communication device with the external device the system is further configured to:
determine a time that the coupling is detected; and
automatically set the alert if the time is within a predetermined time period.

33. The system of claim 27, wherein after detecting the coupling of the mobile communication device with the external device the system is further configured to:
detect when the external device is disconnected from the mobile communication device; and
automatically prevent the alert from being activated, deactivate the alert or suspend the alert.
